(19) United States
(12) Patent Application Publication
(10) Pub. No.: US 2012/0192700 A1
(43) Pub. Date: Aug. 2, 2012

(54) MUSIC DISPLAY SYSTEM

(75) Inventor: Doug Hardy, Adelaide (AU)

(73) Assignee: STARPLAYIT PTY LTD, Adelaide, South Australia (AU)

(21) Appl. No.: 13/375,126

(22) PCT Filed: Jun. 1, 2010
(86) PCT No.: PCT/AU10/00674

§ 371 Date: Apr. 16, 2012

(30) Foreign Application Priority Data
Jun. 1, 2009 (AU) 2009902502

(51) Int. Cl. G09B 15/00

(52) U.S. Cl. 84/485 R

(57) ABSTRACT

The present invention relates to a method of displaying a musical composition for a musical instrument, comprising displaying at least a portion of the musical instrument; displaying, on the musical instrument, a fingering position indicator, indicating a fingering position that is becoming due to be played; and displaying a timing indicator indicating when the fingering position is due to be played. The fingering position indicator may comprise one or more marks on the musical instrument, and the timing indicator may comprise an object moving towards the fingering position indicator on the musical instrument, wherein the object reaches the musical instrument when the fingering position is due to be played. The object and/or the mark may be shaped to indicate an articulation to be played

### PRIORITY CLAIM

This application claims priority from Australian Patent Application No 2009902502, the entire contents of which are hereby incorporated by reference.

### FIELD OF THE INVENTION

The present invention relates to methods and systems for displaying a musical composition, for a musical instrument. The present invention will be described with particular reference to displaying a musical composition for a guitar. However, the present invention has wider application to a range of other instruments.

### BACKGROUND OF THE INVENTION

Musical notation can take a number of different forms. Modern musical notation uses five-line staves, with notes positioned on it. The pitch of each note is shown by its placement on the stave, and its duration is shown by its specific representation or value (e.g. minim, crotchet, quaver). The notation is read from left to right, and each stave typically begins with a clef, key and time signature which show the pitch range, key and timing groupings of the displayed composition.

One feature of modern musical notation is that it uses the same system of notation, regardless of the instrument. Therefore (ignoring for the moment difficulties caused by different pitch ranges and capabilities of different instruments), the same composition can be read by musicians playing (for example) a flute and a violin, without changing the notation.

However, whilst this is convenient and allows for easy translation of a piece between instruments, it does raise some difficulties, especially for beginners. The musical notation does not directly show the user where to place their fingers on the instrument—for example, a beginner pianist is not shown directly which key to press.

Accordingly, alternative forms of musical notation exist, including tablature which shows instrument fingering rather than musical pitches—e.g. directing the musician to place a finger on the 3^{rd} fret of the A string. Tablature is commonly used for fretted instruments, and is simpler for a beginner to read—all they need to do is place their fingers on the indicated string or fret.

However, even using tablature, there is still the issue that the musician must translate between the abstract notation on a page, and the fingering position on the instrument. Furthermore, a musician must use their own sense of timing to ensure that notes or chords are played at the correct time, and for the appropriate duration.

With the widening use of computer software, further variants have been developed for displaying musical composition. These often make use of colour to represent the pitch of each note—for instance, an A may be assigned to the colour pink. However, whilst such colourful displays may appeal to young beginners, many other musicians may prefer other music display systems.

Accordingly, there is still room for further methods of displaying musical compositions which enable musicians to more easily determine how to play their musical instrument, or which at least provide alternatives to existing methods of musical notation.

### SUMMARY OF THE INVENTION

In a first aspect of the present invention, there is accordingly provided a method of displaying a musical composition for a musical instrument, comprising:
displaying at least a portion of the musical instrument;
displaying, on the musical instrument, a fingering position indicator, indicating a fingering position that is becoming due to be played; and
displaying a timing indicator indicating when the fingering position is due to be played.

Within this specification, the reference to “playing” a fingering position will be used to refer to the user positioning their fingers to perform of a note or chord having that fingering position on the instrument. The note or chord may be played by using the fingering position at the required time, to press the relevant key(s) on the instrument, or whilst blowing into the instrument, strumming a string of the instrument or striking the instrument.

The fingering position indicator may take a variety of forms. In some embodiments, it may be a mark displayed on (or in some cases, possibly directly adjacent) a part of the musical instrument (e.g. a key of a piano, a hole on a wind instrument, or a fret of a guitar). The mark may also serve as a timing indicator (in some embodiments a subsidiary timing indicator), by increasing in intensity or changing shape as the fingering position becomes due to play.

The fingering position indicator may indicate the position of one or more fingers on the instrument. If a chord or note requires the use of multiple fingers, multiple fingering position indicators will generally be used to indicate the position of each finger required to play the chord. However, there may be some cases where a single fingering position indicator can be used to represent the position of all of the fingers. The timing of when these fingering positions are due to be played may be indicated using the same or separate timing indicators.

The timing indicator may also take a number of forms. In some embodiments, it could be a countdown timer indicated within or adjacent to each fingering position indicator. However, in one preferred embodiment, the timing indicator is provided by an object depicted to move towards the musical instrument—the object reaches or strikes the musical instrument at the time the fingering position is due to be played. In this case, the fingering position indicator may be a light or shadow cast on the musical instrument by the object. The object and/or the fingering position indicator may have a shape which indicates an articulation that should be played.

The method may further include displaying a duration indicator, indicating the duration for which the fingering position should be played. Where the timing indicator is an object moving towards the instrument, as described above, the object may have a length corresponding to the time for which the fingering position should be played.

In a second aspect of the present invention, there is provided a method of displaying a musical composition for a musical instrument, comprising:
displaying at least a portion of the musical instrument; and
depicting an object moving towards a fingering position on the musical instrument,
wherein, before the object reaches the musical instrument, a mark appears at the fingering position,
and wherein the object reaches the musical instrument when the fingering position is due to be played.

In some embodiments, the object will have a length which indicates the duration for which the fingering position should be played.

The mark may be depicted as a light cast by the object at the fingering position on the musical instrument. Alternatively, the mark could be depicted as a shadow cast by the object at the fingering position.

In a third aspect of the present invention, there is provided a system for displaying a musical composition for a musical instrument, comprising:
a display means;
a processor in communication with the display means, configured to display on the display means:
   at least a portion of the musical instrument,
   on the musical instrument, a fingering position indicator, indicating a fingering position that is becoming due to be played; and
   a timing indicator indicating when the fingering position is due to be played; and
a memory connected to the processor.

In a fourth aspect of the present invention, there is provided an object for indicating features of a fingering position to be played in a musical composition, comprising:
a head, the head for moving towards a position indicating when the fingering position should be played; and
a tail, the tail having a length relative to a duration for which the fingering position should be played.

The tail may be bent to indicate that the fingering position should move it is played, e.g. for string bends, or slurs.

In further aspects of the present invention, there are also provided computer readable media and computer program elements for directing a programmable device to perform the steps of the above method. Yet further aspects of the present invention will be revealed throughout this specification.

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF THE DRAWINGS

An illustrative embodiment of the present invention will be discussed with reference to the accompanying drawings wherein:

FIG. 1 is a screenshot showing the performance of a method according to an embodiment of the present invention;

FIG. 2 depicts a fingering position indicator in accordance with an embodiment of the present invention;

FIG. 3 depicts a timing indicator in accordance with an embodiment of the present invention;

FIG. 4 depicts, in sequence, the operation of the fingering position indicator in FIG. 2 and the timing position indicator of FIG. 3, for a guitar;

FIGS. 5, 7 and 9 are alternative types of timing indicators, in accordance with an embodiment of the present invention;

FIGS. 6, 8 and 10 depict the operation of the timing indicators of FIGS. 5, 7 and 9 respectively; and

FIGS. 11 and 12 depict fingering position indicators for the timing indicators of FIGS. 8 and 10 respectively, in accordance with an embodiment of the present invention.

### DETAILED DESCRIPTION

An embodiment of the present invention is described below with reference to playing a guitar. However, it should be made clear that the present invention may be utilised for many different instruments, including other string instruments, pianos/keyboards, or wind instruments.

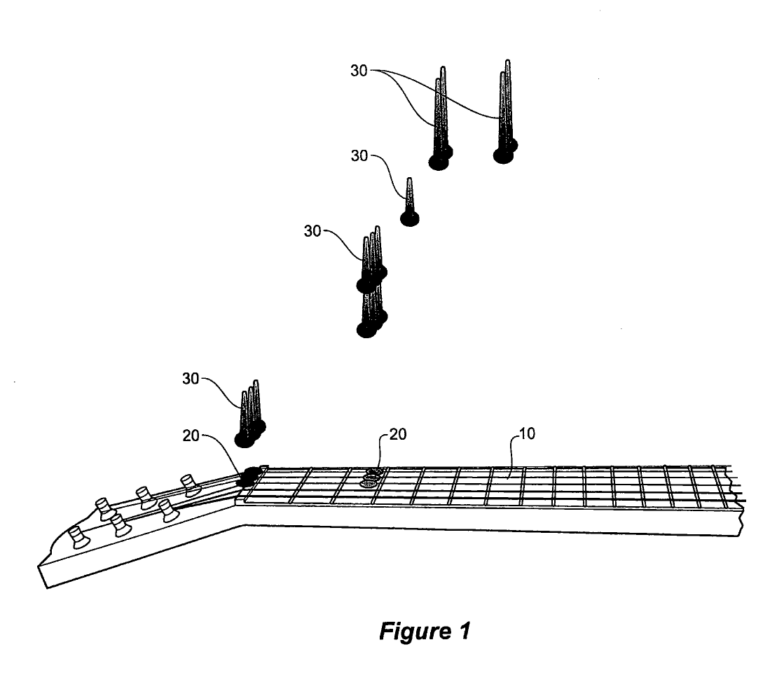

FIG. 1 depicts a screenshot from a computer screen, depicting the method of the present invention. The fretboard 10 of a guitar is displayed along the bottom of the screen. Fingering position indicators 20, or “fretlights” as they are referred to for this embodiment, are shown superimposed on the fretboard 10. These fretlights 20 mark the position on the fretboard 10 where the musician should place their fingers to play the relevant chord. Timing indicators 30, or “notebeams” for the purposes of the description of this embodiment, are shown above the fretboard 10. Various types of known display devices may be used in accordance with the present invention.

During operation, the notebeams 30 fall towards the fretboard 10, and strike the fretboard 10, at a particular fingering position, at the time at which that fingering position should be played. For the ease of the user, the notebeams 30 all fall at the same speed. This speed may vary in accordance with the speed of the music—if the tempo of the music increases, the notebeams 30 will accordingly fall faster. Similarly, if the tempo decreases, the notebeams 30 will fall more slowly.

As a notebeam 30 approaches the fretboard 10, a corresponding fretlight 20 will be displayed on the fretboard 10—the notebeam 30 may be seen to be casting the fretlight 20 on the fretboard 10. Referring to FIG. 1, it can be seen that only the notebeams 30 to the left have corresponding fretlights 20 displayed on the fretboard 10; the notebeams 30 to the right do not have any corresponding fretlights 20 yet, as they are still too far from the fretboard 10. As a notebeam 30 comes closer to the fretboard 10, the corresponding fretlight 20 becomes more intense.

By using the present invention as described above, a musician can keep their eyes on the fretboard 10 as the notebeam 30 approaches—because the fretlights 20 are positioned on the fretboard 10, and show the fingering position before it is due to be played, the musician does not need to look up at the notebeam 30 itself to determine what the fingering position will be. They can simply view the approaching notebeams 30 using their peripheral vision.

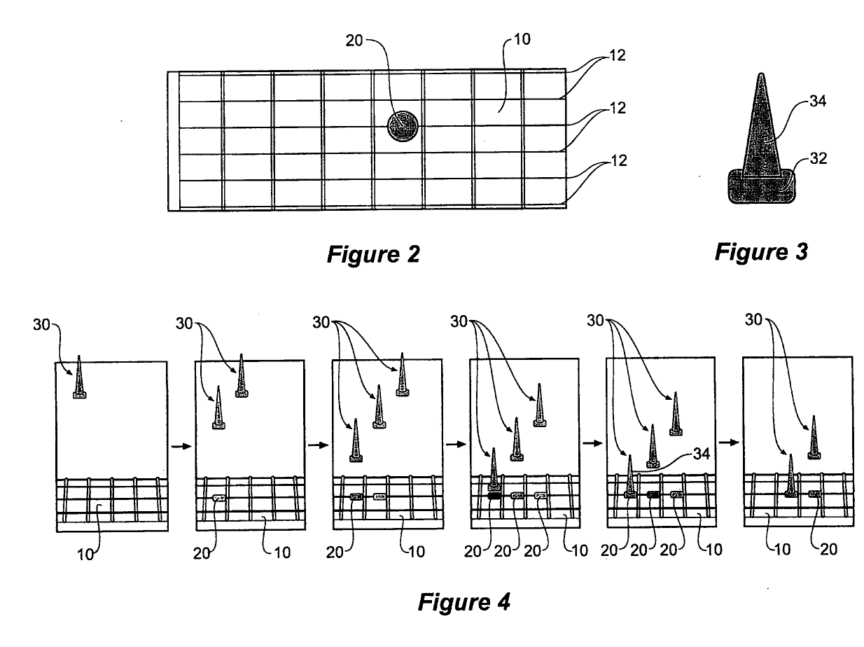

FIG. 2 depicts a fretlight 20 on a fretboard 10, from a top view. The fretlight 20 in this example is round, although may other shapes could be used, and additional shapes will be discussed in further examples of the present invention.

FIG. 3 depicts a form of a notebeam 30 according to an embodiment of the present invention. The notebeam 30 comprises a head or “orb” 32 and an elongate tail 34. The tail 34 provides a duration indicator, in that the length of the tail 34 corresponds to the duration for which the corresponding fingering position should be played. The musician can be assisted in observing the length of the note in intuitive fashion, as follows: when the notebeam 30 strikes the fretboard 10, the orb 32 sinks into the fretboard 10. However, the tail 34 continues to descend at the same rate, even whilst the orb 32 has disappeared from view. The tail 34 eventually disappears from view, when the note should no longer be held.

As can be seen in FIG. 1, notebeams 30 may descend in groups. These notebeams 30 (and fretlights 20 on the fretboard 10) correspond to fingering positions which are to be played at the same time—i.e. they correspond to specific chords in the musical composition. Such groups of notebeams 30 may be referred to as notebeam chords.

FIG. 4 depicts, in sequence, the operation of this embodiment of the present invention. In the first (left-most) frame, a single notebeam 30 is shown descending towards a fretboard 10.

In the next frame of FIG. 4, the first notebeam has descended close enough to the fretboard 10 for a fretlight 20 to appear on the fretboard 10. However, a second notebeam 30 has also appeared, but does not yet have a corresponding fretlight 20, as it is not yet close enough to the fretboard 10.

In the third frame of FIG. 4, the two notebeams from the second frame have descended closer to the fretboard 10, and a third notebeam 30 has also appeared. The middle notebeam 30 now also has a corresponding fretlight 20. However, the fretlight 20 for the left-most notebeam 30 is more intense than the fretlight 20 for the middle notebeam 30.

In the fourth frame of FIG. 4, the notebeams 30 continue descending, until in the fifth frame the orb 32 of the left-most notebeam 30 strikes the fretboard 10, indicating that the corresponding fingering position should be played. The orb 32 “sinks into” the fretboard and disappears from view, whilst the tail 34 continues to descend at the same rate, gradually also disappearing from view until the entire notebeam 30 has disappeared, as shown in the sixth and final frame of FIG. 4. At this time, the next notebeam 30 strikes the fretboard 10, indicating that its fingering position should now be played.

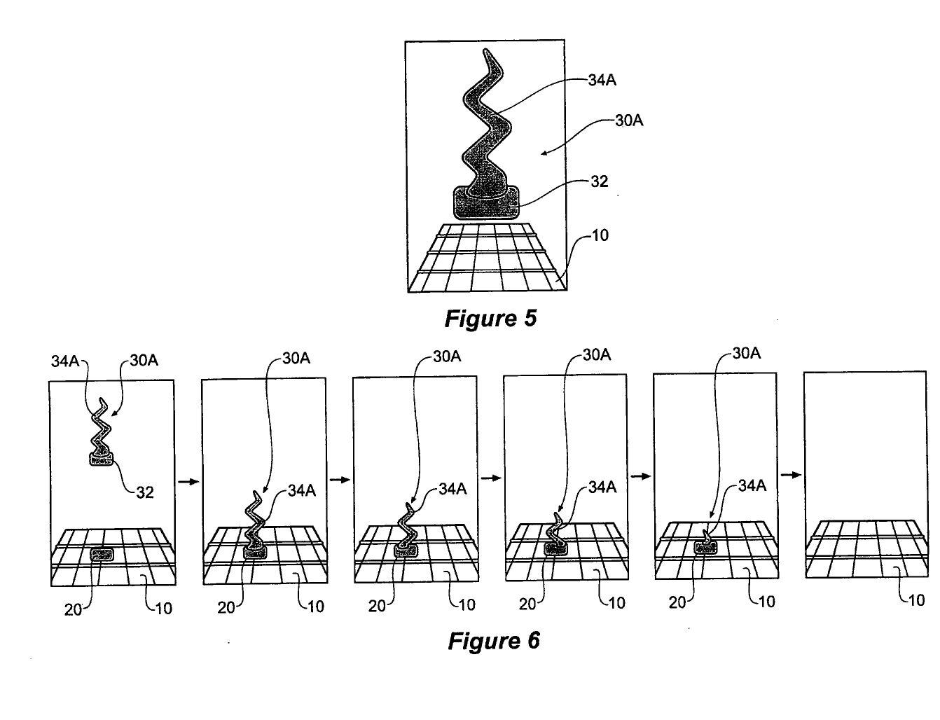

Of course, many variations to the appearance and the operation of the notebeams 30 are possible within the scope of the present invention. These variations depend on the types of information that need to be indicated, and some examples are shown in FIGS. 5 to 10.

In FIG. 5, the shape of a notebeam 30A is used to depict the articulation of the note to be played—the zigzag in the tail 34A of the notebeam indicates that the note is to be played with vibrato. The width of the zigzag can be used to indicate the width of pitch for the vibrato, and the distance between each parallel line can be used to indicate the rate. This vibrato notebeam 30A will operate in substantially the same manner as the standard notebeam described above, as shown in FIG. 6.

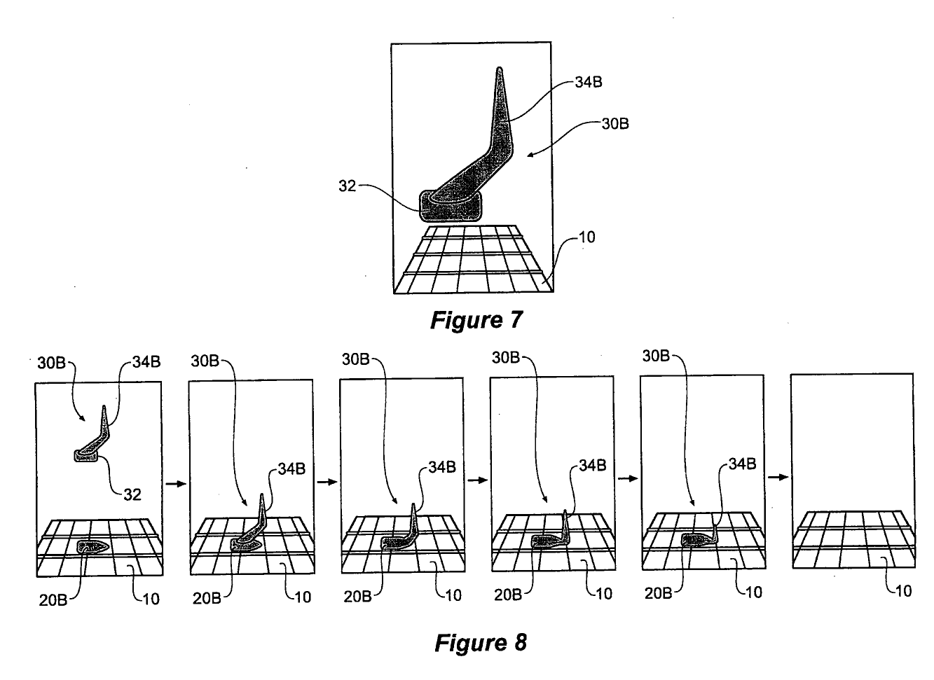

FIG. 7 depicts a bend notebeam 30B, which can be used to indicate a note to be played where the string is bent upward to a higher pitch. The severity of the angle in the bent tail 34B of the bend notebeam 30B can be used to indicate the speed in the change in pitch. The distance from the orb of the notebeam can represent the change in pitch, with a whole tone represented by the distance between two strings.

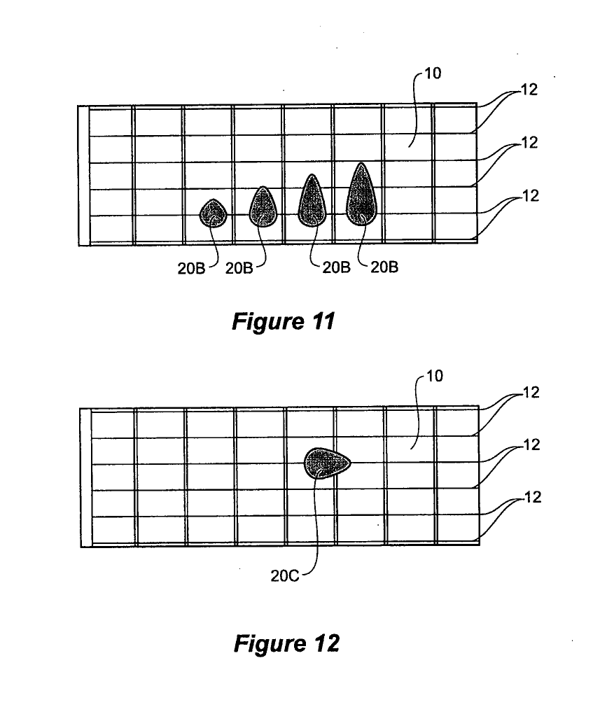

In this case, the corresponding fretlight 20B may also be altered to depict the bend—the fretlight may have a point which corresponds to the amount the string is to be bent, as best shown in FIG. 11. The length of the point indicates the amount that the string is to be bent. FIG. 11 depicts fretlights 20B which indicate bends ranging from a ½ step bend (left-most fretlight 20B), where the point extends halfway to the next string, to a 2 step bend (right-most fretlight 20B), where the point extends to the second string away. During operation of the bend notebeam 30B, as shown in FIG. 8, the straight section of the bent tail 34B aligns directly over the point of the fretlight 20B.

In viewing FIGS. 7 and 8, it should be noted that the bend notebeam 30B has been depicted along the length of the fretboard 10, rather than across the fretboard 10 as shown in the other figures. Of course, the orientation of the fretboard 10 may be changed to suit the preferences of the user, or to best display the requirements of the musical composition.

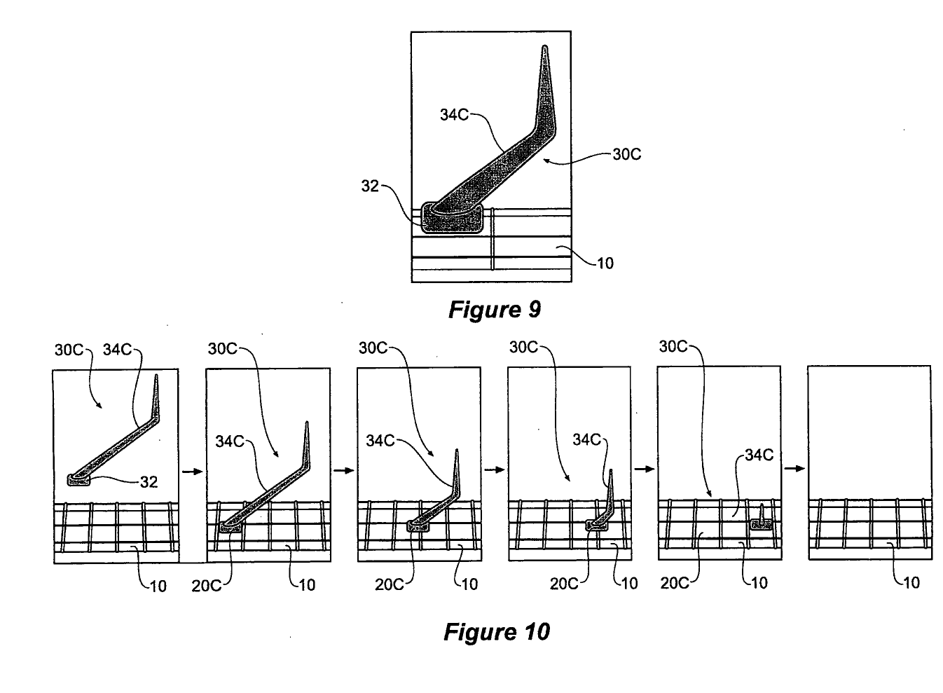

FIG. 9 depicts a slide-up notebeam 30C, which represents an upward slide (or slur) starting and ending at specified pitches. The slide-up notebeam 30C appears similar to the bend notebeam 30B, except of course this similarity is only apparent when the notebeams 30B, 30C are viewed from different orientations—in FIGS. 9 and 10, the slide-up notebeam is shown from across the fretboard. The angled section of the tail 34C of the slide-up notebeam stretches between the starting fret and the ending fret of the slide, such that the end of the tail 34C is positioned over the fret where the slide will end. In this way, the shape of the notebeam 34C indicates the articulation, and shows the user both the initial fingering position, and a subsequent fingering position to which the user should slide their finger.

In some embodiments, it would be possible for the slide-up fretlights 20C to vary in size and shape as described in relation to the bend fretlights 20B described above and shown in FIG. 11. However, in this embodiment, the fretlight 20B is shaped to indicate a slide-up as shown in FIG. 12, but does not vary in size. Rather, as shown in FIG. 10, the fretlight 20C moves along the fretboard indicating the sliding pitch.

Another variation is shown in FIG. 1, in the second group of notebeams 30 from the left. Here, a repeated strum (or re-picking of a note) is shown by having one or more orbs 32 joined to the tail 34 of a notebeam 30—the string is repicked in accordance with the timing indicated as each orb 32 strikes the fretboard 10.

Clearly many more variations in the shape of notebeams 30 and fretlights 20 are possible within the scope of the present invention, depending on the type of information to be indicated. The variations depicted in the figures are far from exhaustive.

For example, string mutes or palm mutes may be represented by differently shaped notebeams 30 or fretlights 20—as these articulations have very short durations, the notebeams may have no tail at all. The fretlights 20 may also be varied so that the user knows that a particular articulation is coming without needing to remove their focus from the fretboard 10.

The method may be formed by a computer device, comprising a central processing unit (CPU) which contains an Input/Output Interface, an Arithmetic and Logic Unit (ALU) and a Control Unit and Program Counter element 134. The CPU will typically be in communication with input and output devices (in particular, a visual display device such as a computer monitor) through the Input/Output Interface, and in communication with a memory.

Although embodiments of the present invention have been described in the foregoing detailed description, it will be understood that the invention is not limited to the embodiment disclosed, but is capable of numerous rearrangements, modifications and substitutions without departing from the scope of the invention. Modifications and variations such as would be apparent to a skilled addressee are deemed within the scope of the present invention.

For example, although the fingering position indicators have been described as bright marks or “fretlights” in the forgoing description, in other embodiments they may be dark (e.g. as shadows cast by the notebeams). In this case, the marks may become darker as the corresponding notebeam approaches.

Furthermore, the orientation of the musical instrument and the approaching notebeams/objects may be altered without departing from the scope of the present invention. For instance, a three-dimensional approach could be taken, wherein the fretboard of a guitar is depicted such that it faces the musician directly, and the notebeams approach from behind the fretboard.

The present invention can also be implemented in numerous ways, including as processes, apparatus, systems, or a computer readable media such as computer readable storage media or computer networks wherein program instructions are sent over optical or electronic communication links.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any prior art in this specification is not, and should not be taken as, an acknowledgment or any form of suggestion that such prior art forms part of the common general knowledge.

1. A method of displaying a musical composition for a musical instrument, comprising:
displaying at least a portion of the musical instrument;
displaying, on the musical instrument, a fingering position indicator, indicating a fingering position that is becoming due to be played; and
displaying a timing indicator indicating when the fingering position is due to be played.

2. The method of claim 1, further comprising:
displaying a duration indicator, indicating the duration for which the fingering position should be played.

3. The method of claim 1, wherein the fingering position indicator comprises one or more marks on the musical instrument.

4. The method of claim 3, further comprising increasing the intensity of the mark as the fingering position becomes due to be played.

5. The method of claim 1, wherein the timing indicator comprises an object moving towards the fingering position indicator on the musical instrument, and wherein the object reaches the musical instrument when the fingering position is due to be played.

6. The method of claim 5, wherein the object has a length which indicates the duration for which the fingering position should be played.

7. The method of claim 6, wherein after the object reaches the fingering position on the musical instrument, it continues to move into the musical instrument for the duration for which the fingering position should be played, until the entire length of the object has reached the musical instrument.

8. The method of claim 5, wherein the object has a shape which indicates an articulation to be performed.

9. The method of claim 8, wherein the object is bent along its length to indicate the articulation.

10. The method of claim 9, wherein the bend in the object is such that, as different parts along the length of the object, the object reaches a subsequent fingering positions, indicating that a user should articulate by playing the fingering position and then moving their finger to the subsequent fingering position.

11. The method of claim 1, wherein the fingering position indicator has a shape which indicates an articulation to be performed.

12. The method of claim 11, wherein the fingering position indicator comprises a first portion indicating the fingering position, and a second portion indicating a subsequent fingering position, wherein the fingering position indicator indicates that a user should articulate by playing the fingering position and then moving their finger to the subsequent fingering position.

13. (canceled)

14. A method of displaying a musical composition for a musical instrument, comprising:
displaying at least a portion of the musical instrument; and
depicting an object moving towards a fingering position on the musical instrument,
wherein, before the object reaches the musical instrument, a mark appears at the fingering position,
and wherein the object reaches the musical instrument when the fingering position is due to be played.

15. The method of claim 14, wherein the object has a length which indicates the duration for which the fingering position should be played.

16. The method of claim 15, wherein after the object reaches mark on the musical instrument, it continues to move into the musical instrument for the duration for which the fingering position should be played, until the entire length of the object has reached the musical instrument.

17. The method of claim 14, wherein the object has a shape which indicates an articulation to be performed.

18. The method of claim 17, wherein the object is bent along its length to indicate the articulation.

19. The method of claim 18, wherein the bend in the object is such that, as different parts along the length of the object, the object reaches a subsequent fingering position, indicating that a user should articulate by playing the fingering position and then moving their finger to the subsequent fingering position.

20. The method of claim 14, wherein the mark has a shape which indicates an articulation to be performed.

21. The method of claim 20, wherein the mark comprises a first portion indicating the fingering position, and a second portion indicating a subsequent fingering position, wherein the mark indicates that a user should articulate by playing the fingering position and then moving their finger to the subsequent fingering position.

22. The method of claim 14, further comprising increasing the intensity of the mark as the fingering position becomes due to be played.

23. The method of claim 1, wherein the musical instrument is a stringed instrument.

24. A system for displaying a musical composition for a musical instrument, comprising:
a display means;
a processor in communication with the display means, configured to display on the display means:
at least a portion of the musical instrument,
on the musical instrument, a fingering position indicator, indicating a fingering position that is becoming due to be played; and
a timing indicator indicating when the fingering position is due to be played; and
a memory connected to the processor.

25. A computer readable medium encoded with data representing a computer program that can be used to direct a programmable device to perform the method of claim 1.
